(19) United States
(12) Patent Application Publication
(10) Pub. No.: US 2025/0342072 A1
(43) Pub. Date: Nov. 6, 2025

(54) MESSAGE QUEUE RESTORATION

(71) Applicant: INTERNATIONAL BUSINESS MACHINES CORPORATION, Armonk, NY (US)

(72) Inventors: Cameron Thomas Doggett, Austin, TX (US); Mark Richard Gambino, Brewster, NY (US); James V. Farmer, Wappingers Falls, NY (US); John Muller, Wappingers Falls, NY (US); Mark David Cooper, Poughkeepsie, NY (US); Leo Giannelli, Brooklyn, NY (US)

(21) Appl. No.: 18/651,802

(22) Filed: May 1, 2024

(51) Int. Cl. G06F 9/54

(52) U.S. Cl. CPC G06F 9/546

(57) ABSTRACT

Embodiments determine evaluation data from at least one message queue, determine a targeted number of messages included in the at least one message queue and a confidence value by using a trained machine learning model with the evaluation data, determine that the confidence value is greater than a predetermined threshold, perform synchronous message restoration based on the targeted number of messages and the confidence value being greater than the predetermined threshold, and perform remaining system restart functions in response to the synchronous message restoration being completed.

### BACKGROUND

Aspects of the present invention relate generally to a system for message queue restoration.

System outages, especially those that are unplanned, require a substantial amount of time and computation to re-establish the system to a normal operational state. For example, during a system restart period, some requests cannot be serviced as critical functions and data structures are restored.

### SUMMARY

In a first aspect of the invention, there is a computer-implemented method including: determining, by a processor set, evaluation data from at least one message queue; determining, by the processor set, a targeted number of messages included in the at least one message queue and a confidence value by using a trained machine learning model with the evaluation data; determining, by the processor set, that the confidence value is greater than a predetermined threshold; performing, by the processer set, synchronous message restoration based on the targeted number of messages and the confidence value being greater than the predetermined threshold; and performing, by the processor set, remaining system restart functions in response to the synchronous message restoration being completed.

In another aspect of the invention, there is a computer program product including one or more computer readable storage media having program instructions collectively stored on the one or more computer readable storage media. The program instructions are executable to: determine evaluation data from at least one message queue; determine a targeted number of messages included in the at least one message queue and a confidence value by using a trained machine learning model with the evaluation data; determine that the confidence value is greater than a predetermined threshold; perform synchronous message restoration based on the targeted number of messages and the confidence value being greater than the predetermined threshold; and perform remaining system restart functions in response to the synchronous message restoration being completed.

In another aspect of the invention, there is a system including a processor set, one or more computer readable storage media, and program instructions collectively stored on the one or more computer readable storage media. The program instructions are executable to: determine evaluation data from at least one message queue; determine a targeted number of messages included in the at least one message queue and a confidence value by using a trained machine learning model with the evaluation data; determine that the confidence value is greater than a predetermined threshold; perform synchronous message restoration based on the targeted number of messages and the confidence value being greater than the predetermined threshold; perform remaining system restart functions in response to the synchronous message restoration being completed; and send a restart success output message in response to performing the remaining system restart functions.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a flowchart of an exemplary method in accordance with aspects of the present invention.

FIG. 5 shows a timeline of a message queue restoration system in accordance with aspects of the present invention.

FIGS. 6-15 show examples of the message queue restoration system in accordance with aspects of the present invention.

### DETAILED DESCRIPTION

Aspects of the present invention relate generally to a system for message queue restoration. Embodiments of the present invention are directed to performing queue restoration as a system is brought back up from a system outage. Aspects of the present invention minimize the overall time spent in a system restart by rebuilding messages that will be immediately needed by applications upon reaching an operational state. Implementations of the present invention rebuild a minimum number of persisted messages per queue in a messaging middleware such that time spent in a system restart is minimized, while still satisfying application and remote system demand immediately upon reaching a normal operation state. In this manner, embodiments of the present invention leverage an evaluation model which comprises coded logic and machine learning to intelligently determine a number of messages to restore to each queue after a system outage. In accordance with aspects of the present invention, the system restores critical messages synchronously to meet an immediate demand when a system comes back up from an outage to enable high throughput, low latency, and maintenance of service level agreements (SLAs). In further embodiments, preferred messages (i.e., non-critical messages) are restored asynchronously concurrently with a system restart. Implementations of the present invention asynchronously reconstruct a preferred group of messages before the time that applications are running to reduce an overall time spent to bring the system back to an operational state. Embodiments of the present invention also leverage recent and historical data in an evaluation model which combines coded rules and machine learning to offer a robust and adaptable solution.

In embodiments of the present invention, a message queueing middleware includes several memory-resident queues enqueued with persistent messages (e.g., messages that are also written to a non-volatile database) to be restored in an event of a system restart or outage. In further embodiments, the enqueue rate represents a rate at which messages are being added to a queue and the dequeue rate represents a rate at which messages are being removed from the queue. In aspects of the present invention, applications dequeue messages from these queues primarily in an order in which they were enqueued (i.e., an order in which the messages are sequentially accessed in a first in, first out basis) while messages on other message queues are transmitted over a network to remote systems in the same order (i.e., an order in which the messages are sequentially accessed in a first in, first out basis). Accordingly, after a system outage, the first (i.e., the oldest) messages present on the front of the queue are rebuilt into memory before the last (i.e., the newest) messages at the end of the queue. During the message queueing middleware processing of the system restart operation, the key output of an evaluation model is how many N messages (N being an integer) to rebuild in the front of the queue with M total messages (M also being an integer) to satisfy application demand upon reaching a normal system operational state in which the applications are up and running again. In further embodiments, the remaining M-N messages are asynchronously restored at a later point in time. In other embodiments, the remaining M-N messages are restored at a later point in time when the M-N messages are needed for dequeue.

Aspects of the present invention restore an optimal number of messages while reducing the overall time spent to bring a system back up from a system restart. In embodiments of the present invention, memory availability during the system restart is not a concern when evaluating how many messages to rebuild because N messages are typically a fraction of the M total messages. For example, as a message queue grows to over 100,000 messages, with each message being approximately a same size, because its enqueue rate of 2,000 messages/second exceeds its dequeue rate of 1,000 messages/second for a period of time before a system outage occurs. Accordingly, in response to the system determining that fifteen seconds worth of application demand of messages is needed to be brought up in an initial time period of the system restart, only 15,000 messages need to be rebuilt by the time the system is back up. Therefore, only 15% of the total message queue (15,000 messages is only 15% of the total queue of 100,000 messages) needs to be rebuilt for the system restart.

Embodiments of the present invention provide a computer-implemented method, a system, and a computer program product for rebuilding critical messages during a synchronous restoration period and rebuilding preferred non-critical messages during an asynchronous restoration period within a system restart. In contrast, conventional systems require additional overhead to bring a system back up. Further, conventional systems rebuild large message queues during a system restart, which drastically increases an overall time to bring a system back up without any benefit to throughput, latency, or handling SLAs. Other conventional systems rebuild a small number of messages during a system restart, which results in a surge of input/output operations as applications begin processing queues and significant consumption of system computational power and memory. Further, these conventional systems also drastically impact the ability for a system to process new requests with the nonnegligible overhead in a timely manner. In particular, embodiments of the present invention determine how much critical message queue restoration is needed as a system is brought back up from a system outage and performs remaining message queue restoration after the critical message queue restoration. Embodiments of the present invention minimize an overall time spent in the system restart by rebuilding critical messages immediately in a synchronous time window so that the critical messages are available for applications when the system reaches a normal operational state.

Embodiments of the present invention include a system, method, and computer program product for providing a message queue restoration with a minimized system restart time. Accordingly, implementations of the present invention provide an improvement (i.e., technical solution) to a problem arising in the technical field of providing message queue restoration due to a system outage. In particular, embodiments of the present invention rebuild only critical messages (typically only a subset of the total messages present) synchronously, which is different from conventional systems which either require additional overhead to bring a system back up or potentially limit servicing of new work in a timely manner due to a surge in operations as applications begin processing queues. Embodiments of the present invention also rebuild non-critical messages during an asynchronous restoration period, which is different from the conventional systems which either require additional overhead to bring a system back up or potentially limits servicing of new work in a timely manner due to a surge in operations as applications begin processing queues. Accordingly, these differences minimize a system restart time which represents an improvement over conventional systems.

Implementations of the present invention are necessarily rooted in computer technology. For example, the step of determining, by a processor set, the targeted number of messages and a confidence value by using a trained machine learning model with evaluation data is computer-based and cannot be performed in the human mind. Determining the targeted number of messages using the machine learning model is, by definition, performed by a computer and cannot practically be performed in the human mind (or with pen and paper) due to the complexity and massive amounts of operations involved. For example, training and building the machine learning model in embodiments of the present invention includes using machine learning to build and train the machine learning model using recent and historical data, environmental data, and message queue data to improve the accuracy of determining critical message queues within a system. In particular, training and building the machine learning model uses a large amount of processing recent and historical data, environmental data, and message queue data and modeling of parameters to train the machine learning model such that the machine learning model outputs a number of critical messages in real time (or near real time). Given the scale and complexity of processing recent and historical data, environmental data, and message queue data and modeling of parameters, it is simply not possible for the human mind, or for a person using pen and paper, to perform the number of calculations involved in training and/or building the machine learning model.

Aspects of the present invention include a method, system, and computer program product for managing message queues of a middleware infrastructure after a restart by rebuilding a minimum number of persisted messages per queue. For example, a computer-implemented method includes: retrieving usage patterns, factors, and message processing environment data corresponding to a selected queue from a database; performing an evaluation of the usage patterns, the factors, and the message processing environment data corresponding to each respective queue of a set of queues in main memory; inputting the usage patterns, the factors, and the message processing environment data corresponding to the selected queue into a machine learning module of a queue state evaluation component; determining, using the machine learning model, a target number of messages to rebuild onto the selected queue from persistent storage along with a confidence score based on the usage patterns, the factors, and the message processing environment data corresponding to the selected queue; determining, using the coded rules module of a queue state evaluation component, a target number of messages to rebuild onto the selected queue from persistent storage based on the usage patterns, the factors, and the message processing environment data corresponding to the selected queue; determining, using the outputs (i.e., targets) of the machine learning and coded rules modules, the actual target number of messages to rebuild onto the selected queue based on whether the confidence score from the machine learning model meets a predetermined threshold, constituting the output by the broader evaluation component; categorizing the messages into the three group of required (i.e., synchronous), preferred (i.e., asynchronous), and low priority or deferred; and restoring the messages based on the three groups.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as message queue restoration code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

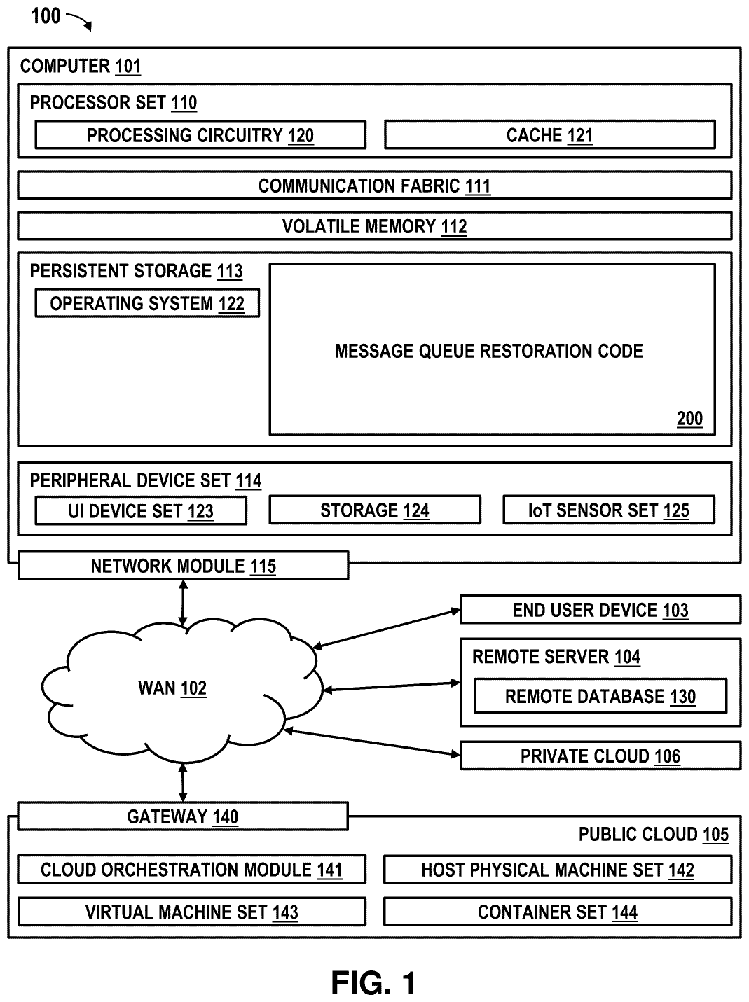

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

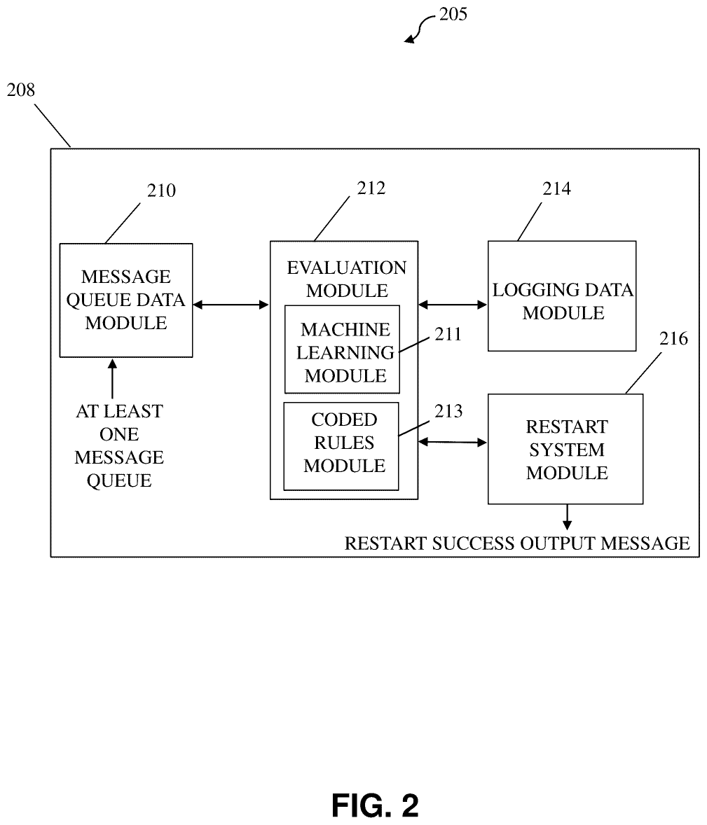

FIG. 2 shows a block diagram of an exemplary environment 205 in accordance with aspects of the present invention. In embodiments, the environment 205 includes a message queue restoration server 208, which may comprise one or more instances of the computer 101 of FIG. 1. In other examples, the message queue restoration server 208 comprises one or more virtual machines or one or more containers running on one or more instances of the computer 101 of FIG. 1.

In embodiments, the message queue restoration server 208 of FIG. 2 comprises a message queue data module 210, an evaluation module 212, a logging data module 214, and a restart system module 216, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the present invention as described herein. These modules of the code of block 200 are executable by the processing circuitry 120 of FIG. 1 to perform the inventive methods as described herein. The message queue restoration server 208 may include additional or fewer modules than those shown in FIG. 2. For example, the evaluation module 212 may comprise a machine learning module 211 and a coded rules module 213 as shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In aspects of the present invention, the message queue data module 210 receives at least one message queue and determines evaluation data which includes at least one of recent data, historical data, environmental data, queue-specific data, etc. In further embodiments, the message queue data module 210 determines the evaluation data which includes at least one of a dequeue rate, a type of system outage (e.g., planned, unplanned, etc.), a duration of the system outage, a current time of data, remote system states, anticipated time of next remote system maintenance, queue priority, queue depth, enqueue rate, average message size, and recent network bandwidth utilization based on the at least one message queue, system properties, recent message data, historical message data, remote system properties, and network properties. In embodiments of the present invention, the memory queue data module 210 sends the evaluation data which includes at least one of the dequeue rate, the type of system outage (e.g., planned, unplanned, etc.), the duration of the system outage, the current time of data, the remote system states, the anticipated time of next remote system maintenance, the queue priority, the queue depth, the enqueue rate, the average message size, and the recent network bandwidth utilization to the evaluation module 212.

In the example shown in FIG. 2, the evaluation module 212 comprises the machine learning module 211 and the coded rules module 213. In this example, the machine learning module 211 and the coded rules module 213 of the evaluation module 212 receive the evaluation data which includes at least one of the dequeue rate, the type of system outage (e.g., planned, unplanned, etc.), the duration of the system outage, the current time of data, the remote system states, the anticipated time of next remote system maintenance, the queue priority, the queue depth, the enqueue rate, the average message size, and the recent network bandwidth utilization. In embodiments, the enqueue rate represents a rate at which messages are being added to the at least one message queue, the dequeue rate represents a rate at which messages are being removed from the at least one message queue, and the queue depth represents the number of messages in the at least one message queue. In further embodiments, the evaluation module 212 builds and trains the machine learning model, such as a neural network, of the machine learning module 211 based on the evaluation data in order to solve a regression problem described (i.e., determining a targeted number of messages to rebuild). In aspects of the present invention, the evaluation module 212 utilizes the machine learning module 211 to determine and output a targeted number of messages for the at least one message queue. In further embodiments, the targeted number of messages represents the number of critical messages that need to be synchronously restored during a system restart. In aspects of the present invention, the machine learning module 211 utilizes the machine learning model to determine and output the targeted number of messages for the at least one message queue.

In an aspect of the present invention, the targeted number of messages determined by the machine learning module 211 comprises a single number which represents the number of critical messages that need to be synchronously restored during the system restart. In further embodiments, the targeted number of messages comprise the single number which represents the number of critical messages that need to be synchronously restored, up to a predetermined time allowance of the system restart. In other embodiments, the targeted number of messages comprise another single number which when multiplied with a predetermined factor (e.g., 50%) represents the number of messages that need to be synchronously restored while the remaining messages (e.g., 50%) of the targeted number of messages need to be asynchronously restored. For example, the evaluation module 212 utilizes the machine learning module 211 to output the targeted number of messages being 1,000 messages for a queue of 10,000 messages with a time allowance of five seconds. In this scenario, the system restart module 216 restores 700 messages during the time allowance of five seconds during synchronous restoration and then rebuilds the remaining 300 messages concurrently with the rest of the system being restarted. In another example, the evaluation module 212 utilizes the machine learning module 211 to output the targeted number of messages being 1,000 messages for a queue of 10,000 messages and applies a predetermined factor of 0.6 to determine the number of messages for synchronous restoration (i.e., 600) and the remaining number of targeted messages rebuilt (i.e., 400 remaining messages) concurrently with system restart continuing. In this scenario, the system restart module 216 restores 600 targeted messages during synchronous restoration and then rebuilds the remaining 400 messages concurrently with the rest of the system being restarted. In another embodiment, the targeted number of messages comprise a first number and a second number. In this scenario, the first number represents the number of critical messages that need to be synchronously restored and the second number represents the preferred number of messages (i.e., non-critical number of messages) that are asynchronously restored with the rest of the system being restarted. In an example, the system restart module 216 restores the first number of 750 targeted messages during synchronous restoration and then rebuilds the second number of 250 remaining messages concurrently with the rest of the system being restarted. However, embodiments are not limited to these examples, and the system restart module 216 may perform restoration during a system restart using different embodiments for the targeted number of messages.

In an aspect of the present invention, the machine learning module 211 of the evaluation module 212 is continuously trained with more evaluation data using the machine learning model to improve the accuracy of the targeted number of messages. Although the machine learning model of the machine learning module 211 uses a neural network to solve the defined regression problem, embodiments are not limited. The machine learning model can utilize other machine learning algorithms that are capable of iteratively improving the accuracy of the targeted number of messages. In embodiments of the present invention, the machine learning module 211 outputs the targeted number of messages to the logging data module 214 which logs historical targeted number of messages for training the machine learning module 211. In aspects of the present invention, the machine learning model of the machine learning module 211 also determines a confidence value associated with the determined targeted number of messages.

In further embodiments of FIG. 2, the coded rules module 213 of the evaluation module 212 also determines and outputs the targeted number of messages for the at least one message queue based on predetermined rules. Implementations of the present invention utilize the coded rules module 213 to determine and output the targeted number of messages for the at least one message queue in a situation where the confidence value associated with the determined targeted number of messages in the machine learning module 211 is equal to or less than a predetermined threshold. In aspects of the present invention, the coded rules module 213 of the evaluation module 212 determines the targeted number of messages based on predetermined rules of the evaluation data. In an example, the coded rules module 213 of the evaluation module 212 determines the targeted number of messages for the at least one message queue based on predetermined rules of the dequeue rate and the average message size. In aspects of the present invention, the predetermined rules may be a rules based algorithm which is configured to be changed by at least one of a system administrator, a software programmer, a user, etc. As described above with respect to the machine learning module 211, the targeted number of messages determined by the coded rules module 213 may represent a critical number of messages that need to be synchronously restored during a time allowance of the system restart, may represent a target number of messages with an applied factor to determine which need to be synchronously restored versus asynchronously restored, or may represent a first number which represents the number of critical messages that need to be synchronously restored and a second number which represents the preferred number of messages (i.e., non-critical number of messages) that are asynchronously restored with the rest of the system being restarted.

In aspects of the present invention with regards to FIG. 2, the evaluation module 212 compares the confidence value determined by the machine learning module 211 with the predetermined threshold. In embodiments, the predetermined threshold may be defined by one of a system administrator, a user, etc. In further embodiments, the evaluation module 212 selects the targeted number of messages based on the machine learning module 211 in response to determining that the confidence value determined by the machine learning module 211 is greater than the predetermined threshold. In this scenario, the evaluation module 212 outputs the targeted number of messages determined by the machine learning module 211 to the restart system module 216. In other embodiments, the evaluation module 212 selects the targeted number of messages based on the coded rules module 213 in response to the determining that the confidence value determined by the machine learning module 211 is equal to or less than the predetermined threshold. In this scenario, the evaluation module 212 outputs the targeted number of messages determined by the coded rules module 213 to the restart system module 216.

Still referring to FIG. 2, the restart system module 216 receives the targeted number of messages from one of the machine learning module 211 or the coded rules module 213 and performs synchronous message restoration based on the targeted number of messages. In particular, the restart system module 216 restarts a system after a system outage and performs the synchronous message restoration for a time allowance period based on the targeted number of messages. Therefore, the restart system module 216 restarts the system and performs the synchronous message restoration for the targeted number of messages (i.e., the critical number of messages). The restart system module 216 determines whether the synchronous message restoration has been completed by determining whether the targeted number of messages have been restored within the time allowance. In other words, the restart system module 216 determines that the synchronous message restoration has been completed in response to the targeted number of messages being restored before the time allowance has elapsed. The restart module 216 waits for the time allowance period to be elapsed in response to determining that the synchronous message restoration has not been completed. In this scenario, the restart module 216 performs asynchronous message restoration for non-critical messages in response to the time allowance period being elapsed. The restart module 216 then performs the remaining system restart functions and then sends the restart success output message in response to the remaining system restart functions being completed.

In further embodiments of FIG. 2, the restart module 216 performs remaining system restart functions in response to determining that the synchronous message restoration has been completed (i.e., the critical number or messages have been restored). In this scenario, the restart module 216 sends the restart success output message in response to the remaining system restart functions being completed.

In embodiments of the present invention, the evaluation module 212 provides the targeted number of messages to the restart system module 216 such that the system is able to restore as many messages as possible given the time and resource constraints. Accordingly, implementations of the present invention provide a maximum amount of message queue restoration when sufficient time and resources exist which helps to protect against any unforeseen surge in application demands. In further embodiments, the evaluation module 212 provides the targeted number of messages that are synchronously restored within a time allowance. In aspects of the present invention, the system is able to rebuild extra messages after the targeted number of messages have been synchronously restored given that there is still time available with the time allowance, other queues which have yet to meet their targets are being actively restored, sufficient computation and memory resources exist, and there is at least one other queue being worked on by another process that has yet to meet its target. Accordingly, the remaining system restart functions can continue early with the at least one other queue being asynchronously restored if all of the targeted number of messages have been synchronously restored before the time allowance period has elapsed. In other embodiments, there may be some message queues that have persistent messages that have yet to be restored into memory by the time the system is fully operational again. In this scenario, these persistent messages should be reconstructed intelligently just before they are needed for dequeue or transmission to avoid overwhelming system resources.

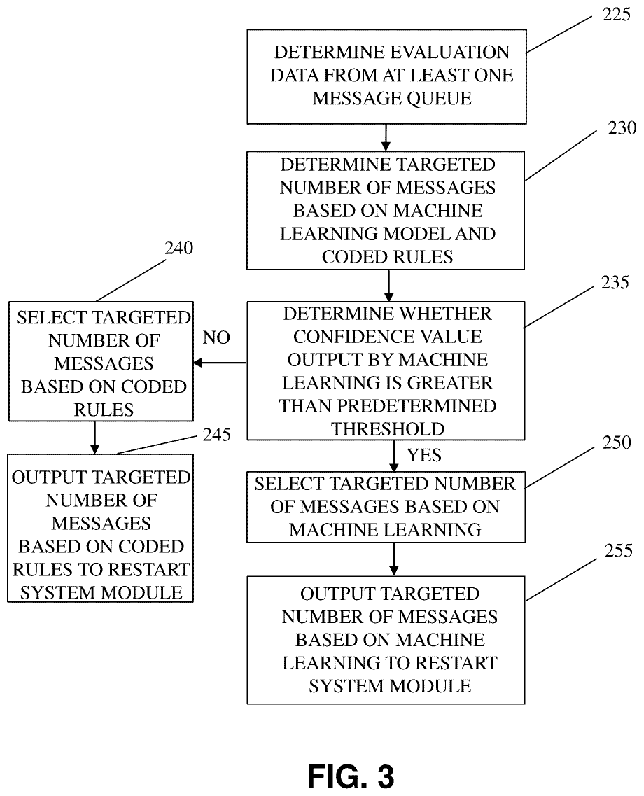

FIG. 3 shows a flowchart of an exemplary method in accordance with aspects of the present invention. Steps of the method may be carried out in the environment of FIG. 2 and are described with reference to elements depicted in FIG. 2.

At step 225, the system determines, at the message queue data module 210, evaluation data which includes at least one of a dequeue rate, a type of system outage, a duration of the system outage, a current time of day, remote system states, anticipated time of next remote system maintenance, queue priority, queue depth, enqueue rate, average message size, and a recent network bandwidth utilization from at least one message queue. In embodiments and as described with FIG. 2, the message queue data module 210 sends the evaluation data to the evaluation module 212.

At step 230, the system determines, at the evaluation module 212, a targeted number of messages based on a machine learning model and coded rules. In embodiments and as described with FIG. 2, the evaluation module 212 utilizes the machine learning model of the machine learning module 211 to determine a targeted number of messages and a confidence value associated with the determined targeted number of messages. In embodiments and as described with FIG. 2, the evaluation module 212 utilizes the coded rules of the coded rules module 213 to determine the targeted number of messages.

At step 235, the system determines, at the evaluation module 212, whether the confidence value determined by the machine learning module 211 is greater than a predetermined threshold. In embodiments and as described with FIG. 2, the predetermined threshold may be defined by one of a system administrator, a user, etc. At step 240, the system selects, at the evaluation module 212, the targeted number of messages based on the coded rules of the coded rules module 213 in response to the confidence value determined by the machine learning module 211 being less than or equal to the predetermined threshold. At step 245, the system outputs, at the evaluation module 212, the targeted number of messages based on the coded rules of the coded rules module 213 to the restart system module 216.

At step 250, the system selects, at the evaluation module 212, the targeted number of messages based on machine learning module 211 in response to the confidence value determined by the machine learning module 211 being greater than the predetermined threshold. At step 255, the system outputs, at the evaluation module 212, the targeted number of messages based on machine learning to the restart system module 216.

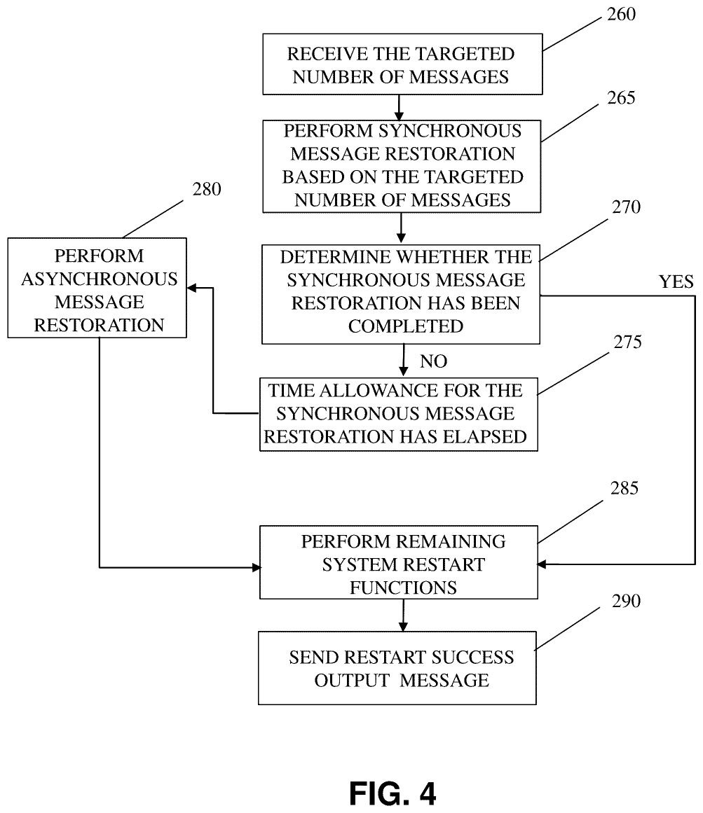

FIG. 4 shows a flowchart of an exemplary method in accordance with aspects of the present invention. Steps of the method may be carried out in the environment of FIG. 2 and are described with reference to elements depicted in FIG. 2. In addition, FIG. 4 is an extension of the steps of the method in FIG. 3.

At step 260, the system receives, at the restart system module 216, the targeted number of messages. In aspects of the present invention, step 260 is performed after one of steps 245 and 255 in FIG. 3 have been completed. In embodiments and as described with FIG. 2, the targeted number of messages are received from one of the coded rules module 213 and the machine learning module 211 based on the confidence value output by the machine learning module 211. At step 265, the system performs, at the restart system module 216, synchronous message restoration based on the received targeted number of messages.

At step 270, the system determines, at the restart system module 216, whether the synchronous message restoration has been completed. In embodiments and as described with FIG. 2, the restart system module 216 determines that the synchronous message restoration has been completed in response to completing rebuild of the targeted number of messages. At step 285, the system performs, at the restart system module 216, remaining system restart functions in response to the system determining that the synchronous message restoration has been completed. At step 290, the system sends, at the restart system module 216, a restart success output message to the system.

At step 275, the system determines, at the restart system module 216, that a time allowance for the synchronous message restoration has elapsed in response to the system determining that the synchronous message restoration has not been completed. At step 280, the system performs, at the restart system module 216, an asynchronous message restoration in response to the time allowance for the synchronous message restoration has elapsed. At step 285, the system performs, at the restart system module 216, remaining system restart functions in response to the system performing the asynchronous message restoration. At step 290, the system sends, at the restart system module 216, a restart success output message to the system.

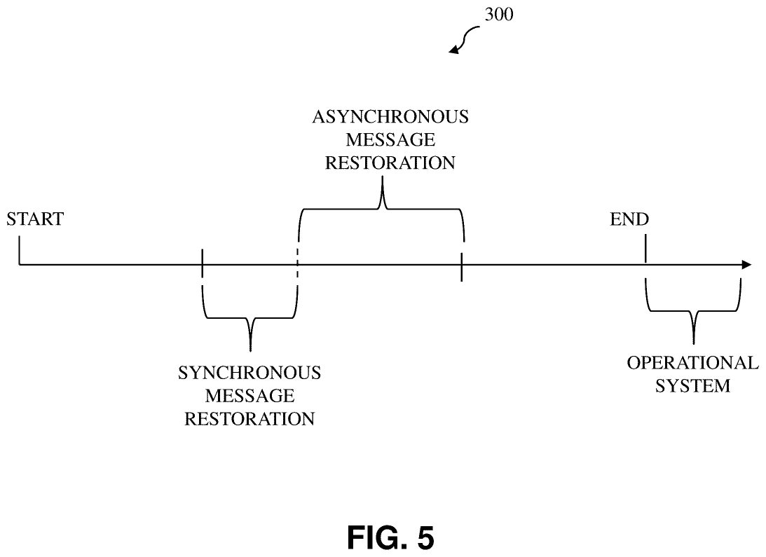

FIG. 5 shows a timeline of a message queue restoration system in accordance with aspects of the present invention. In aspects of the present invention, FIG. 5 shows a timeline which corresponds with step 265 of FIG. 4 (i.e., synchronous message restoration) and step 280 of FIG. 4 (i.e., asynchronous message restoration). In embodiments, the message queue restoration system includes rebuilding memory-resident messages queues as part of the restart system process. In further embodiments, the timeline 300 includes a synchronous message restoration time period in which the targeted number of messages (e.g., the critical number of messages) are rebuilt. In further aspects of the present invention, the timeline 300 also includes an asynchronous message restoration in which remaining messages (e.g., non-critical number of messages) are rebuilt. In further embodiments, in the timeline 300, the system is operational after the message queue restoration period is completed and all other important system functions are reestablished (labeled as “END”).

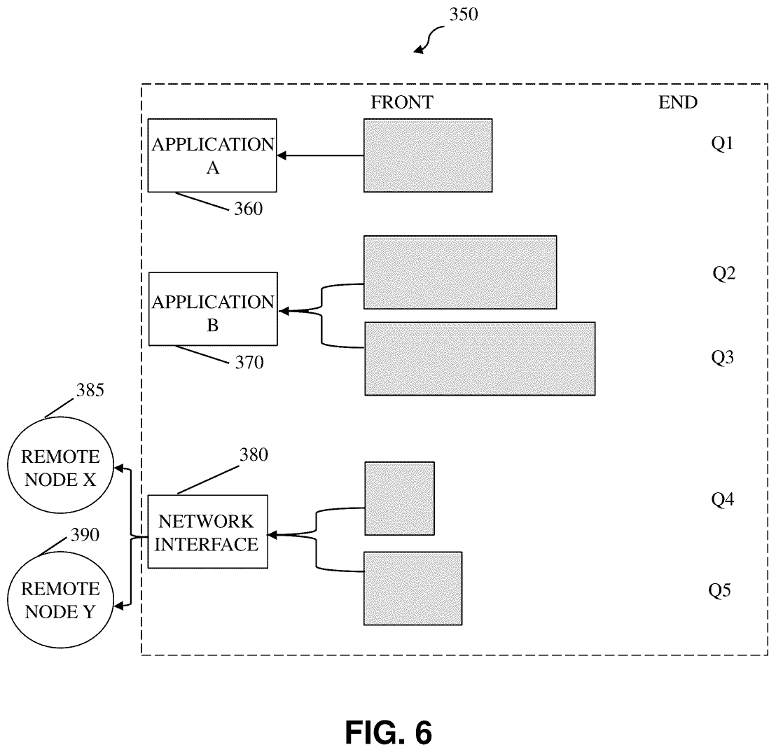

FIGS. 6-15 show examples of the message queue restoration system in accordance with aspects of the present invention. In an example of a running system 350 in FIG. 6, the running system 350 includes an application A 360, an application B 370, and a network interface 380. In this example, a remote node X 385 and a remote node Y 390 are external to the running system 350. The running system 350 also includes message queues Q1, Q2, Q3, Q4, and Q5. In this example, the message queue Q1 is dequeued to application A 360, the message queues Q2 and Q3 are dequeued to application B 370, and the message queues Q4 and Q5 are transmitted to the network interface 380. The network interface 380 then sends the message queues Q4 and Q5 to the remote node X 385 and the remote node Y 390, respectively. The volume of messages present on each message queue is indicated by the length of each bar and the gray shade denotes that all of the messages are currently in memory.

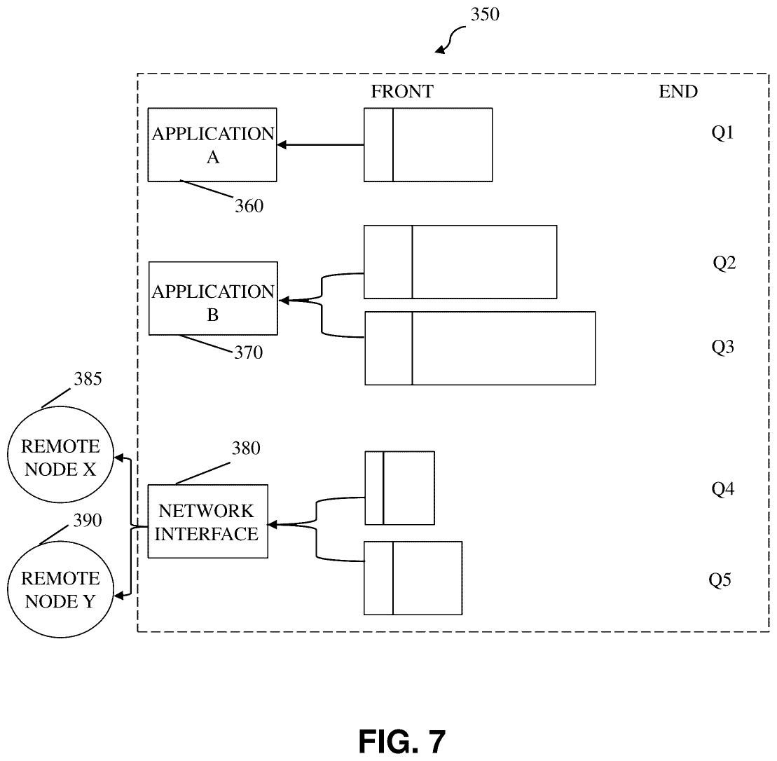

In FIG. 7, the running system 350 is brought down gracefully by an operator and restarted. In embodiments, FIGS. 7-15 are snapshots of the running system 350 in FIG. 6 at different points in time. In this situation, all memory has been cleared, applications (e.g., application A 360 and application B 370) are not running, and the network functionality (e.g., network interface 38) isn't fully restored. The restart system module restarts the system and each of the message queues (e.g., message queues Q1, Q2, Q3, Q4, and Q5) are evaluated to determine how many messages to rebuild. In this scenario, the evaluation module 212, through the machine learning module 211 and the coded rules module 213, determines to rebuild a targeted number of messages which are proportional to each dequeue rate of each message queue before the system outage. For example, 10 seconds of messages (i.e., 10* the dequeue rate) may be targeted for restoration per queue. In FIG. 7, the vertical line in each bar indicates the end of the synchronous message restoration time period.

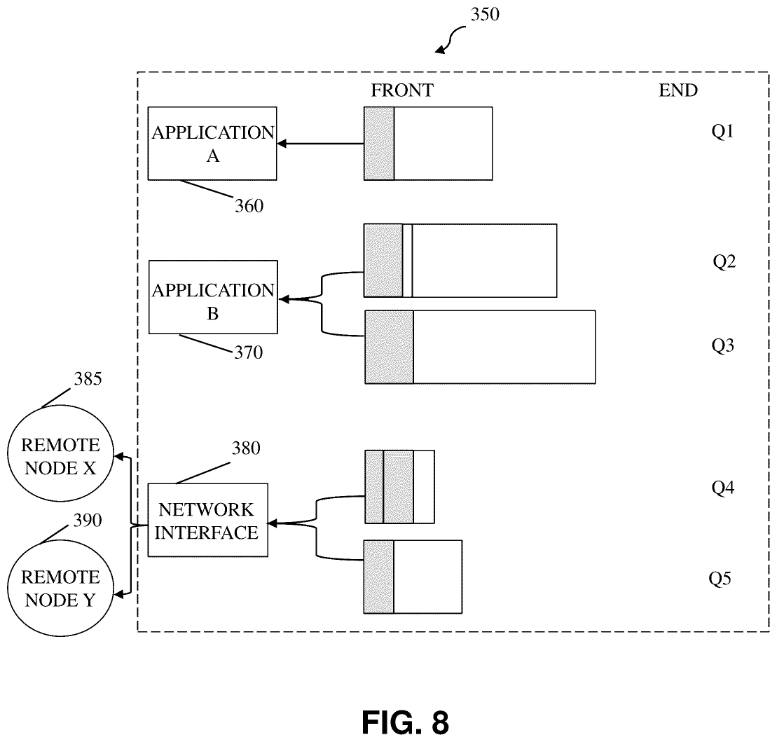

In FIG. 8, the running system 350 includes the message queues (e.g., message queues Q1, Q2, Q3, Q4, and Q5) with the targeted number of messages being rebuilt to a front of the message queue through the synchronous message restoration time period of the timeline 300. In further embodiments, the messaging query Q2 has messages restored in the asynchronous message restoration time period until the target has been met. In FIG. 8, the vertical line in each bar indicates the intended restoration target by the end of the synchronous message restoration time period.

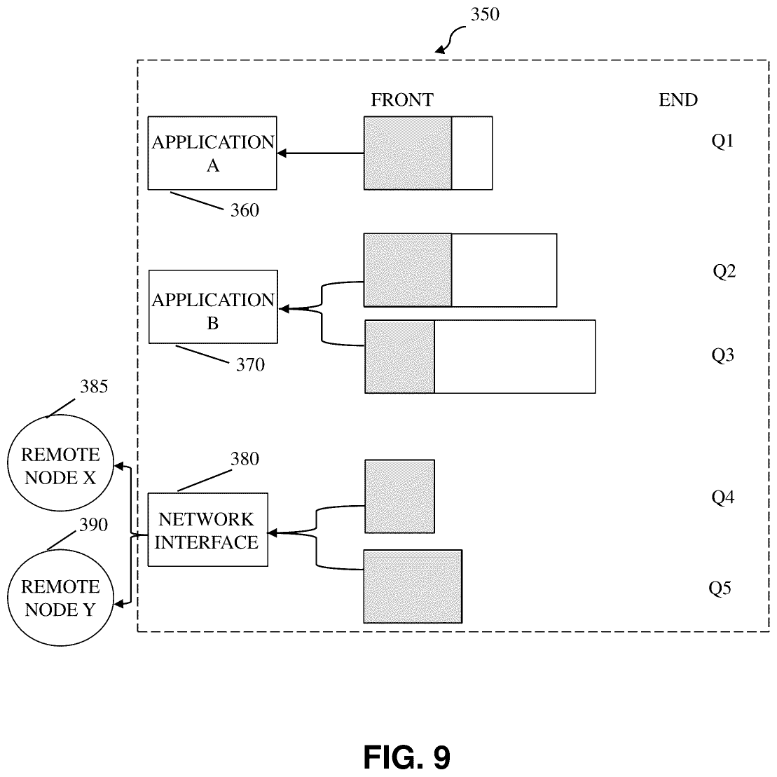

In FIG. 9, the running system 350 shows that the restart system module returns the system to a normal operational state. Further, applications (e.g., application A 360 and application B 370) are dequeuing and the messages are being transmitted over the network interface 380. In further embodiments, remaining messages (i.e., messages other than the targeted number of messages) which were not restored into memory during the system restart will be restored as the message queues (e.g., message queues Q1, Q2, Q3) continue to be processed.

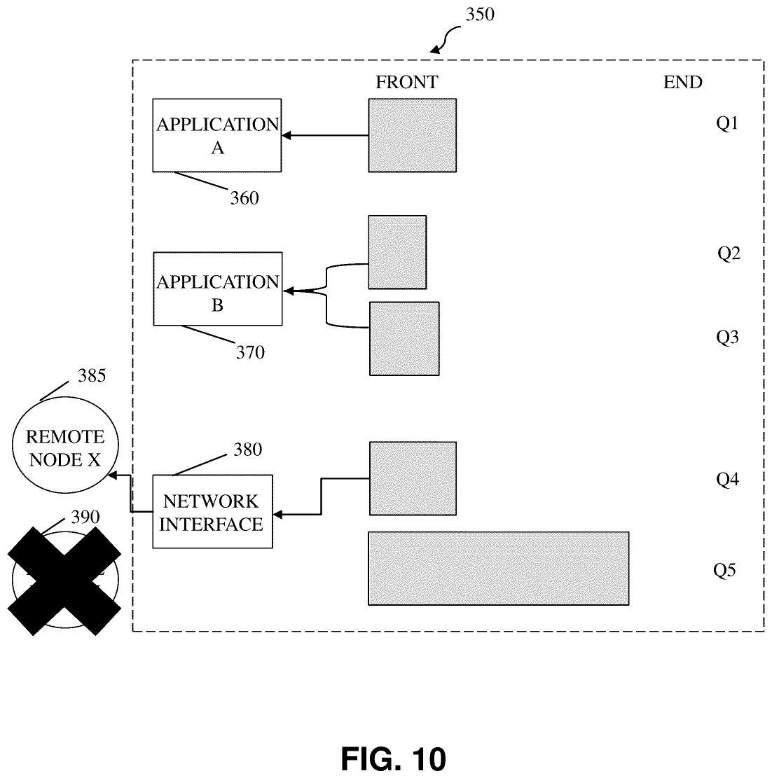

In FIG. 10, the running system 350 shows the system operating early in a morning on a specific day. In aspects of the present invention, FIGS. 10-12 are a different example from the process shown in FIGS. 7-9. In this example, message queue Q5 is outbound to remote node Y 390 through the network interface 380. However, the remote node Y 390 is currently undergoing prolonged maintenance. Thus, message queue Q5 cannot be sent. In further embodiments, message queue Q5 slowly grows in size as additional messages continue to arrive onto the message queue Q5. Accordingly, the system then takes a short, planned outage.

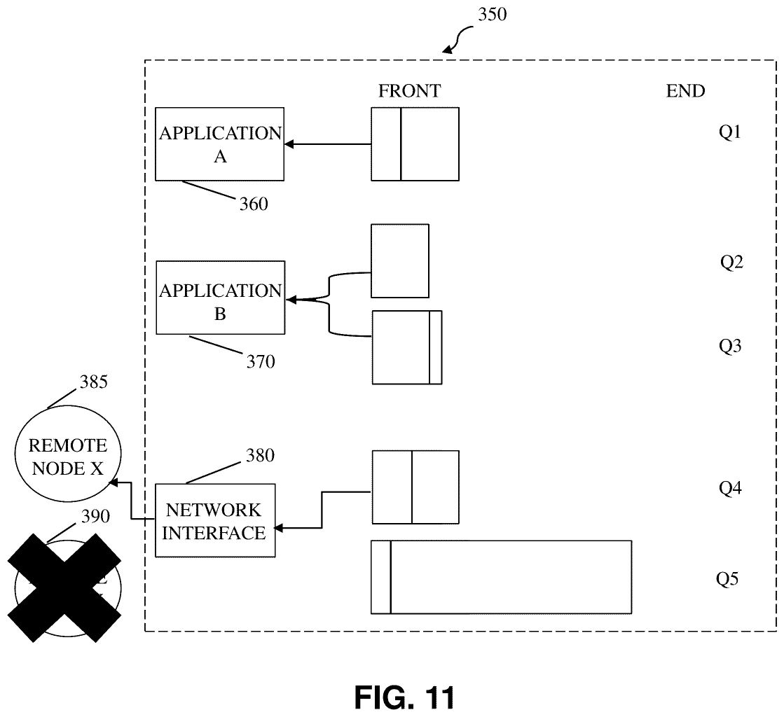

In FIG. 11, the running system 350 shows that the message queues (e.g., message queues Q1, Q2, Q3, Q4, and Q5) are evaluated for their restoration targets a few minutes later than the process shown in FIG. 10. In this scenario, all of the message queues except for the message queue Q5 have their targets set per their dequeue rates just before the system outage. In further embodiments, message queue Q5 has its target set artificially low by the evaluation module 212 because the machine learning module 211 identifies that a destination node (i.e., the remote node Y 390) will continue to be down for maintenance for a long period of time during the system outage. Accordingly, it is unnecessary for the system to take the time to rebuild all of the messages in the message queue Q5.

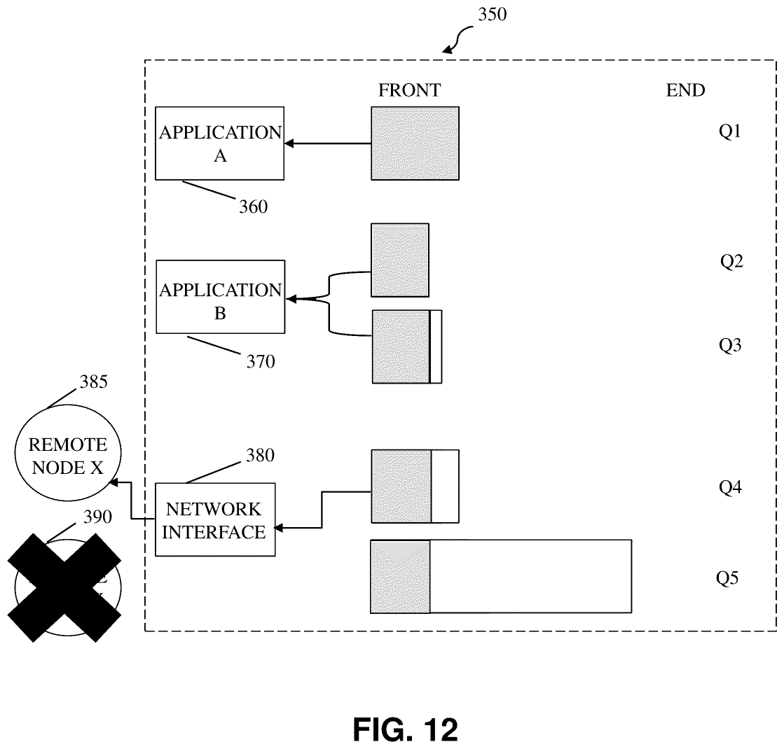

In FIG. 12, the running system 350 shows the system of FIG. 10 running with a minimum number of messages to meet an immediate demand and deferring most of the restoration of the message queue Q5. Eventually, the remote node Y 390 becomes active again. At this point, message queue Q5 has a significant number of its message restored in a slow manner so as to prevent later bottlenecking during the transmission (i.e., performing input/output to read the messages back in). Accordingly, in aspects of the present invention, the running system 350 prevents issues that may occur with service level agreements (SLAs).

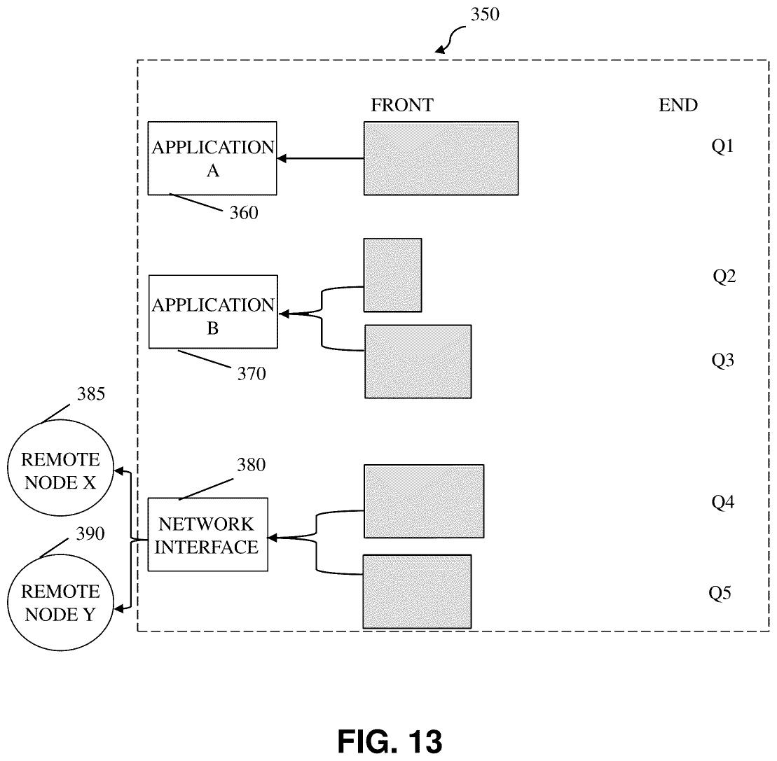

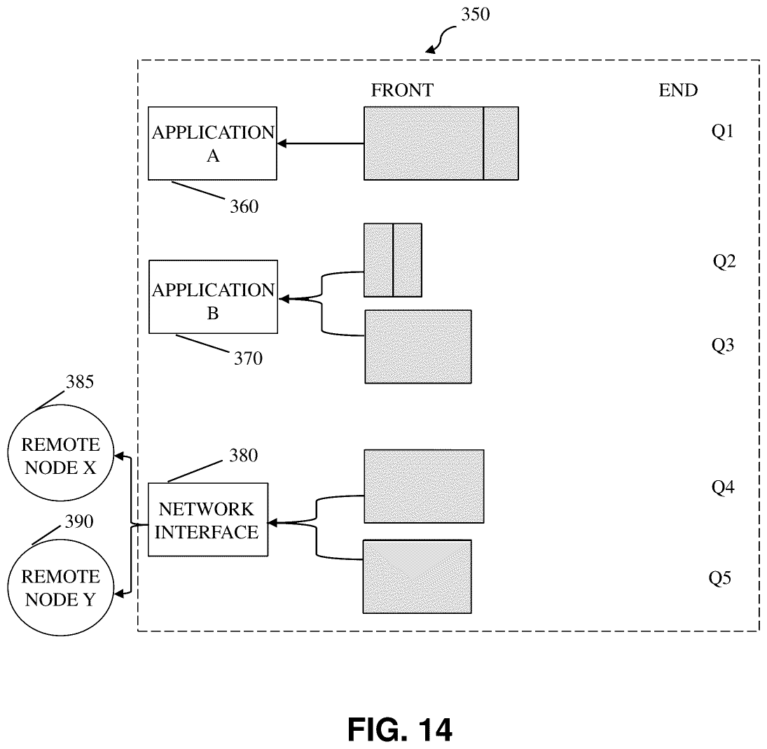

In FIG. 13, the running system 350 shows the system operating normally during an evening on a specific day. In aspects of the present invention, FIGS. 13-15 are a different example from the process shown in FIGS. 7-9 and the process shown in FIGS. 10-12. Then, the system encounters an expected system outage. In FIG. 14, the running system 350 shows the system being brought back up three days later than the process shown in FIG. 13 and during a busy time of day. As a consequence, the machine learning module 211 becomes far more aggressive with its targets by anticipating a surge in demand because of the time of day and the fact that the system was down for such an elongated time period.

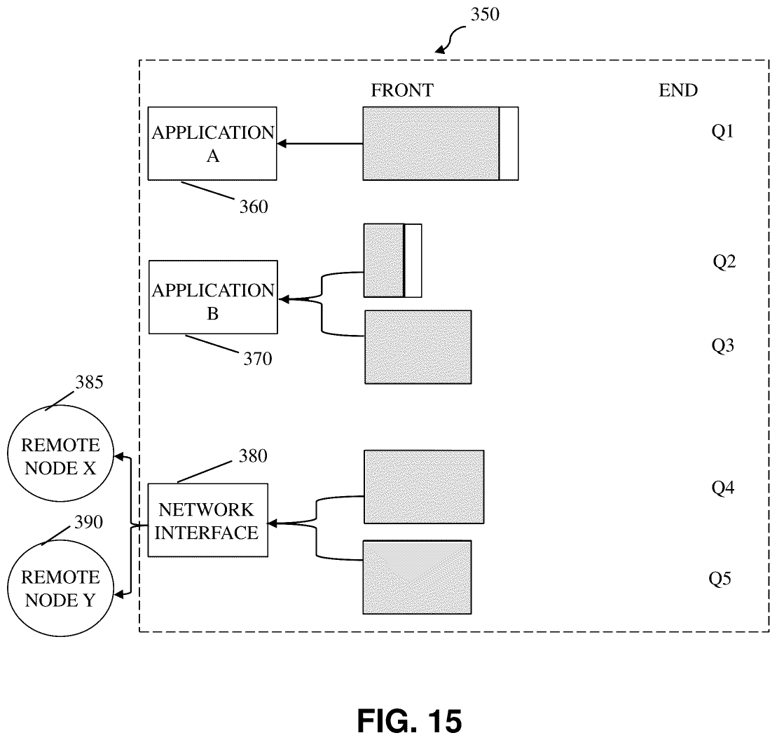

In FIG. 15, the running system 350 shows that the system of FIG. 14 is operational again. Accordingly, the message queues (e.g., message queues Q1, Q2, Q3, Q4, and Q5) and the system as a whole are subjected to greater application demand as the system catches up for the days of missed activity. Therefore, in the system, by having restored a greater number of messages prior to coming up, dequeues and transmits are less likely to be blocked and waiting to read in the next message.

In embodiments, a service provider could offer to perform the processes described herein. In this case, the service provider can create, maintain, deploy, support, etc., the computer infrastructure that performs the process steps of the present invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the present invention provides a computer-implemented method, via a network. In this case, a computer infrastructure, such as computer 101 of FIG. 1, can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
determining, by the processor set, evaluation data from at least one message queue;
determining, by the processor set, a targeted number of messages included in the at least one message queue and a confidence value using a trained machine learning model with the evaluation data;
determining, by the processor set, that the confidence value is greater than a predetermined threshold;
performing, by the processor set, synchronous message restoration based on the targeted number of messages and the confidence value being greater than the predetermined threshold; and
performing, by the processor set, remaining system restart functions in response to the synchronous message restoration being completed.

2. The computer-implemented method of claim 1, further comprising determining the targeted number of messages based on coded rules.

3. The computer-implemented method of claim 1, wherein the performing the remaining system restart functions comprises restoring remaining messages of the at least one message queue.

4. The computer-implemented method of claim 3, wherein the remaining messages comprise messages of the at least one message queue other than the targeted number of messages.

5. The computer-implemented method of claim 1, wherein the evaluation data is selected from the group consisting of a dequeue rate, a type of system outage, a duration of the system outage, a current time of data, remote system states, an anticipated time of a next remote system maintenance, a queue priority, a queue depth, an enqueue rate, an average message size, and a network bandwidth utilization.

6. The computer-implemented method of claim 1, wherein the evaluation data is selected from the group consisting of a dequeue rate and an average message size.

7. The computer-implemented method of claim 1, wherein the synchronous message restoration is completed in response to restoring the targeted number of messages.

8. The computer-implemented method of claim 1, further comprising sending a restart success output message in response to the performing the remaining restart functions.

9. The computer-implemented method of claim 1, further comprising training the machine learning model with the evaluation data.

10. The computer-implemented method of claim 9, wherein the training the machine learning model with the evaluation data further comprises a neural network using the evaluation data to solve a defined regression problem.

11. The computer-implemented method of claim 1, wherein the targeted number of messages represents a targeted number of critical messages.

12. A computer program product comprising one or more computer readable storage media having program instructions collectively stored on the one or more computer readable storage media, the program instructions executable to:
determine evaluation data from at least one message queue;
determine a targeted number of messages included in the at least one message queue and a confidence value by using a trained machine learning model with the evaluation data;
determine that the confidence value is greater than a predetermined threshold;
perform synchronous message restoration based on the targeted number of messages and the confidence value being greater than the predetermined threshold; and
perform remaining system restart functions in response to the synchronous message restoration being completed.

13. The computer program product of claim 12, wherein the program instructions are further configured to determine the targeted number of messages based on coded rules.

14. The computer program product of claim 12, wherein the program instructions to perform the remaining system restart functions are further configured to restore remaining messages of the at least one message queue.

15. The computer program product of claim 14, wherein the remaining messages comprise messages of the at least one message queue other than the targeted number of messages.

16. The computer program product of claim 12, wherein the evaluation data is selected from the group consisting of a dequeue rate, a type of system outage, a duration of the system outage, a current time of data, remote system states, an anticipated time of a next remote system maintenance, a queue priority, a queue depth, an enqueue rate, an average message size, and a network bandwidth utilization.

17. The computer program product of claim 12, wherein the synchronous message restoration has been completed in response to restoring the targeted number of messages.

18. The computer program product of claim 12, where the program instructions are further configured to send a restart success output message in response to the performing the remaining restart functions.

19. The computer program product of claim 12, wherein the targeted number of messages represents a targeted number of critical messages.

20. A system comprising:
a processor set, one or more computer readable storage media, and program instructions collectively stored on the one or more computer readable storage media, the program instructions executable to:
determine evaluation data from at least one message queue;
determine a targeted number of messages included in the at least one message queue and a confidence value by using a trained machine learning with the evaluation data;
determine that the confidence value is greater than a predetermined threshold;
perform synchronous message restoration based on the targeted number of messages and the confidence value being greater than the predetermined threshold;
perform remaining system restart functions in response to the synchronous message restoration being completed; and
send a restart success output message in response to performing the remaining system restart functions.
